(19) United States
(12) Patent Application Publication
(10) Pub. No.: US 2023/0062651 A1
(43) Pub. Date: Mar. 2, 2023

(54) CRANKSHAFT BEARING STRUCTURE

(71) Applicant: MAZDA MOTOR CORPORATION, Hiroshima (JP)

(72) Inventors: Hirotaka TAMARI, Aki-gun (JP); Shigeru WADA, Aki-gun (JP); Yukio MISAKI, Aki-gun (JP); Koji KUMAGAI, Aki-gun (JP); Tatsunori SASAKI, Aki-gun (JP); Takahiro ONDA, Aki-gun (JP)

(73) Assignee: MAZDA MOTOR CORPORATION, Hiroshima (JP)

(21) Appl. No.: 17/817,527

(22) Filed: Aug. 4, 2022

(30) Foreign Application Priority Data
Aug. 27, 2021 (JP) 2021-138994

(51) Int. Cl. F16C 9/02; F16C 17/10

(52) U.S. Cl. CPC F16C 9/02; F16C 17/10

(57) ABSTRACT

A crankshaft bearing structure is provided capable of properly lubricating a thrust bearing even when low-viscosity oil is used in an engine. The crankshaft bearing structure includes a crankshaft, a cylinder block, plural journal bearings, and thrust bearings. Each of the plural journal bearings is annularly attached to a respective one of plural crank journals when the crankshaft is rotating. The thrust bearings are attached to a shaft support section, which supports the crank journal, in the cylinder block, to restrict movement of the crankshaft in a direction along an axis. The upper journal bearing annularly attached to the crank journal has a circumferential groove provided in an inner circumferential surface, connected to an oil hole, and extending in a circumferential direction.

### TECHNICAL FIELD

The present disclosure relates to a crankshaft bearing structure and, in particular to, an arrangement mode of a thrust bearing.

### BACKGROUND ART

A vehicle engine includes a crankshaft that outputs rotary drive power. The crankshaft is supported by a bearing section including a bearing cap and an end portion of a bulkhead in a cylinder block. A journal bearing is inserted between the bearing section, which includes the bulkhead and the bearing cap, and a crank journal of the crankshaft. In addition, a thrust bearing that restricts movement of the crankshaft in an axial direction is inserted between the crankshaft and a pair of the bulkhead and the bearing cap.

In Japanese Patent Document JP-A-2015-34572, in a front view in the axial direction of the crankshaft, the journal bearing is constructed by combining an upper journal bearing and a lower journal bearing, each of which has a semicircular shape. The upper journal bearing is formed with a circumferential groove in an inner circumferential surface thereof, and the circumferential groove extends in a circumferential direction in a manner to be connected to an oil hole that serves as an oil supply port from an oil gallery. In a structure disclosed in JP-A-2015-34572, oil that is supplied from the oil gallery is guided to the lower journal bearing by using the circumferential groove as a guide path. The circumferential groove, which is provided to the inner circumferential surface of the upper journal bearing, also functions as a guide path for discharging a granular foreign substance such as metal power to the outside from a portion between the crank journal and the journal bearing.

In Japanese Patent Document JP-A-05-60124, the following structure is disclosed. The thrust bearing is disposed between a second crank journal from a power output side of the crankshaft and a pair of the bulkhead and the bearing cap disposed on one side in the axial direction of the crank journal. In the structure disclosed in JP-A-05-60124, the oil that is supplied from the oil gallery to the portion between the crank journal and the journal bearing is guided in the axial direction of the crankshaft to lubricate the thrust bearing.

In recent years, low-viscosity oil has been used to improve engine fuel economy. When low-viscosity oil is used in the engine, just as described, the fuel economy can be improved by reducing sliding resistance. However, when the temperature of the oil becomes high due to driving of the engine or the like, hydraulic pressure is reduced. For this reason, in order to maintain the appropriate hydraulic pressure, a load of an oil pump has to be increased. However, this hinders the improvement in fuel economy.

It has also been considered to adopt the following configuration for all of the upper journal bearings and the lower journal bearings to maintain the hydraulic pressure even when low-viscosity oil is used in the engine and the temperature of the low-viscosity oil becomes high. In this configuration, the circumferential groove like the one provided in the upper journal bearing disclosed in JP-A-2015-34572 is not provided. In this case, where the circumferential groove is not provided to the inner circumferential surface of the journal bearing, a volume of a clearance between an outer circumferential surface of the crank journal and the inner circumferential surface of the journal bearing is reduced, which is advantageous for maintaining the hydraulic pressure.

### SUMMARY

However, there is a concern that, if the circumferential groove is not provided in the inner circumferential surface of the journal bearing, the amount of oil that is discharged in the axial direction of the crankshaft from the portion between the crank journal and the journal bearing is reduced, which results in insufficient lubrication of the thrust bearing.

The present disclosure has been made to solve such a problem and therefore has a purpose of providing a crankshaft bearing structure capable of favorably lubricating a thrust bearing even when low-viscosity oil is used in an engine.

A crankshaft bearing structure according to an aspect of the present disclosure includes a crankshaft, a cylinder block, plural journal bearings, and a thrust bearing. The crankshaft has plural crank journals, each of which extends in a specified direction, and which are disposed at mutually-spaced intervals in the specified direction. The cylinder block has plural shaft support sections, each of which is disposed to surround a radially outer side of a respective one of the plural crank journals, and supports the crankshaft in a rotatable manner by the plural shaft support sections. Each of the plural journal bearings is provided between a respective one of the plural crank journals and a respective one of the plural shaft support sections, and is annularly attached to the respective one of the plural crank journals when the crankshaft is rotating. The thrust bearing is attached to each of some shaft support sections of the plural shaft support sections to restrict movement of the crankshaft in the specified direction.

In the crankshaft bearing structure according to this aspect, the cylinder block has an oil path. Some journal bearings of the plural journal bearings each have: an oil hole that is provided in an upper portion and is connected to the oil path, and through which oil from the oil path is supplied to a portion between the journal bearing and the crank journal; and a circumferential groove that is provided in an inner circumferential surface of the journal bearing, is connected to the oil hole, and extends in a circumferential direction. The thrust bearing is attached to the shaft support section for supporting the crank journal, to which the some journal bearings are annularly attached.

In the crankshaft bearing structure according to the above aspect, the some journal bearings each have the circumferential groove. As a result, a relatively large amount of the oil is supplied to the portion between the some journal bearings and the crank journal, to which the some journal bearings are annularly attached. In addition, in the crankshaft bearing structure according to the above aspect, the thrust bearing is attached to the shaft support section for supporting the crank journal, to which the some journal bearings are annularly attached. In other words, in the crankshaft bearing structure according to the above aspect, the thrust bearing is disposed in a portion corresponding to each of the some journal bearings. Accordingly, the relatively large amount of the oil is discharged in the specified direction from a portion between the crank journal and each of the some journal bearings, each of which corresponds to the portion where the thrust bearing is disposed. As a result, lubrication of the thrust bearing is favorably maintained.

Therefore, in the crankshaft bearing structure according to the above aspect, even when low-viscosity oil is used in an engine and a temperature of the low-viscosity oil becomes high, the lubrication of the thrust bearing is favorably maintained.

In the crankshaft bearing structure according to the above aspect, the some journal bearings may include a specific single first journal bearing, and the thrust bearings may include: a first thrust bearing that is arranged adjacent to one side of the first journal bearing in the specified direction; and a second thrust bearing that is arranged adjacent to an opposite side of the first journal bearing from the one side in the specified direction.

In the crankshaft bearing structure according to the above aspect, the first thrust bearing and the second thrust bearing are arranged adjacent to both of the sides of the single first journal bearing, which is included in the some journal bearings, in the specified direction. Accordingly, it is possible to reliably lubricate both of the thrust bearings by a relatively large amount of the oil discharged in the specified direction from a portion between the first journal bearing and the crank journal, to which the first journal bearing is attached, while restricting the movement of the crankshaft in the specified direction.

In the crankshaft bearing structure according to the above aspect, the plural crank journals may include: a specific single first crank journal; and a specific single second crank journal that is a different crank journal from the first crank journal. The some journal bearings may include: a first journal bearing that is annularly attached to the first crank journal; and a second journal bearing that is annularly attached to the second crank journal. The thrust bearings may include: a first thrust bearing that is arranged adjacent to one side of the first journal bearing in the specified direction; and a second thrust bearing that is arranged adjacent to an opposite side of the second journal bearing from the one side in the specified direction.

In the crankshaft bearing structure according to the above aspect, The first thrust bearing is arranged adjacent to the one side of the first journal bearing, which is included in the some journal bearings, in the specified direction. The second thrust bearing is arranged adjacent to the other side (the opposite side from the one side) of the second journal bearing, which is included in the some journal bearings, in the specified direction. Accordingly, it is possible to restrict the movement of the crankshaft in the specified direction. In addition, the first thrust bearing is arranged adjacent to the first journal bearing, and the second thrust bearing is arranged adjacent to the second journal bearing. As a result, a relatively large amount of the oil is supplied to each of the thrust bearings from a portion between the respective adjacent journal bearing and the crank journal, to which the respective adjacent journal bearing annularly is attached. Therefore, it is possible to favorably lubricate both of the thrust bearings.

In the crankshaft bearing structure according to the above aspect, each of the plural journal bearings may be constructed of an upper journal bearing and a lower journal bearing, each of which has a semicircular shape in front view in the specified direction, and the circumferential groove in each of the some journal bearings may only be provided to the upper journal bearing.

In the crankshaft bearing structure according to the above aspect, since the circumferential groove is provided in the inner circumferential surface of the upper journal bearing, the oil that is supplied through the oil hole of the upper journal bearing is guided toward the lower journal bearing.

Meanwhile, the circumferential groove is not provided to the lower journal bearing that is disposed vertically below the upper journal bearing, and this is advantageous for securing an appropriate hydraulic pressure between the lower journal bearing and the crank journal.

In the crankshaft bearing structure according to the above aspect, a circumferential end surface of each of the upper journal bearing and the lower journal bearing may be formed such that, when circumferential end portions of the upper journal bearing and the lower journal bearing abut each other, a groove extending in the specified direction is formed on an inner circumferential surface side of the abutting portion.

In the crankshaft bearing structure according to the above aspect, the groove that extends in the specified direction is formed in the abutting portion of the circumferential end portions of the upper journal bearing and the lower journal bearing. Accordingly, the oil is easily supplied to the thrust bearing, which is arranged adjacent to the journal bearing, from the portion between the journal bearing and the crank journal.

In the crankshaft bearing structure according to the above aspect, the thrust bearing may be constructed of an upper thrust bearing and a lower thrust bearing, each of which has a semicircular shape in the front view in the specified direction.

In the crankshaft bearing structure according to the above aspect, since the thrust bearing is configured by combining the upper thrust bearing and the lower thrust bearing, the thrust bearing can easily be attached to the cylinder block.

In the crankshaft bearing structure according to the above aspect, a remaining journal bearing that differs from the some journal bearings of the plural journal bearings may have: an inner circumferential surface that is configured as a rotation surface generated with a linear line parallel to the specified direction as a generating line; and an oil hole that is provided in an upper portion and is connected to the oil path, and through which the oil from the oil path is supplied to a portion between the inner circumferential surface and the crank journal.

In the crankshaft bearing structure according to the above aspect, the inner circumferential surface of the remaining journal bearing is configured as the rotation surface. In other words, the inner circumferential surface of the remaining journal bearing is not formed with the circumferential groove. Accordingly, even when the low-viscosity oil is used and the temperature of the low-viscosity oil becomes high, it is possible to secure the appropriate hydraulic pressure between the journal bearing and the crank journal.

In the crankshaft bearing structure according to each of the above aspects, the thrust bearing can favorably be lubricated even when the low-viscosity oil is used in the engine.

### BRIEF DESCRIPTION OF THE DRAWINGS

FIG. 1 is a schematic view illustrating a crankshaft bearing structure according to a first embodiment.

FIG. 2 is a side view illustrating an arrangement mode of a crank journal, journal bearings, and thrust bearings.

FIG. 3 is a cross-sectional view illustrating shaft internal oil paths in a crankshaft.

FIG. 4A is a perspective view illustrating a structure of upper and lower journal bearings that are annularly attached to a #1 crank journal, and FIG. 4B is a perspective view illustrating the structure of the upper journal bearing therein.

FIG. 5A is a perspective view illustrating a structure of upper and lower journal bearings that are annularly attached to a #4 crank journal, and FIG. 5B is a perspective view illustrating the structure of the upper journal bearing therein.

FIG. 6A is a cross-sectional view illustrating an oil flow between the #1 crank journal and the journal bearings, and FIG. 6B is a cross-sectional view illustrating an oil flow between the #4 crank journal and the journal bearings.

FIG. 7 is a cross-sectional view illustrating an oil flow from upper and lower journal bearings, which are annularly attached to the #4 crank journal, to the thrust bearings.

FIG. 8 is a schematic view illustrating a crankshaft bearing structure according to a second embodiment.

### DETAILED DESCRIPTION

A description will hereinafter be made on embodiments of the present disclosure with reference to the drawings. The embodiments, which will be described below, each exemplify the present disclosure, and the present disclosure is not limited to the following embodiments in any respect except for an essential configuration thereof.

### First Embodiment

### 1. Schematic Configuration of Crankshaft Bearing Structure 100

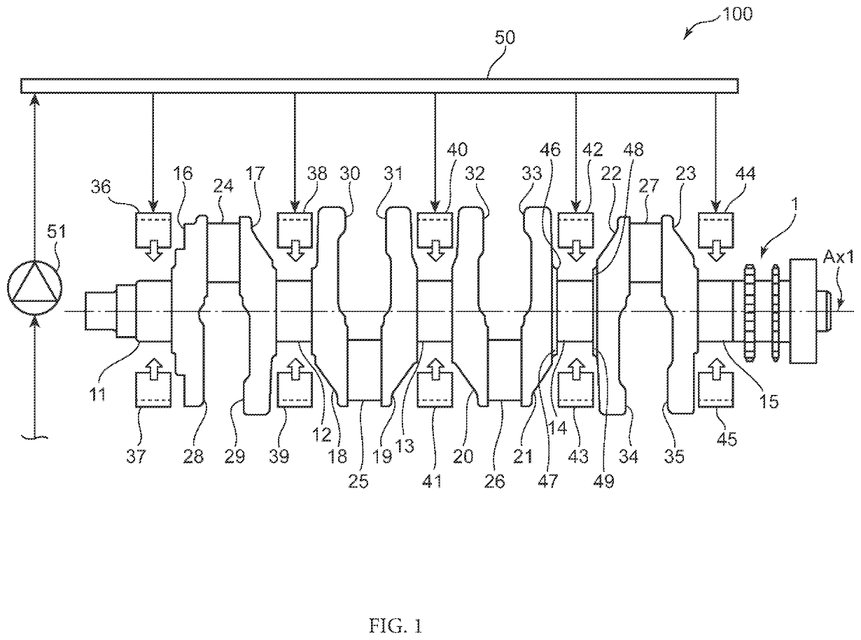

A description will be made on a schematic configuration of a crankshaft bearing structure 100 according to a first embodiment of the present disclosure with reference to FIG. 1. In FIG. 1, a cylinder block and the like are not illustrated. Accordingly, in FIG. 1, a shaft support section that is formed in the cylinder block is not illustrated, either. Furthermore, in FIG. 1, a connecting rod that is connected to a crankshaft 1, a connecting rod bearing, and the like are not illustrated, either.

As illustrated in FIG. 1, the crankshaft bearing structure 100 includes a crankshaft 1, the cylinder block (not illustrated), plural journal bearings 36 to 45, and plural thrust bearings 46 to 49. The crankshaft bearing structure 100 also includes: an oil gallery 50 that is formed in the cylinder block (not illustrated); and an oil pump 51 that feeds oil to the oil gallery 50.

The crankshaft 1 extends along an axis Ax1. In this embodiment, a direction in which the axis Ax1 extends is a cylinder bank direction of an engine, and corresponds to the “specified direction”. The crankshaft 1 has plural crank journals 11 to 15 that are disposed at mutually-spaced intervals in a direction along the axis Ax1. The crankshaft 1 also has crank pins 24 to 27, each of which is disposed between a respective adjacent pair of the crank journals 11 to 15 in the direction along the axis Ax1.

In the crankshaft 1, the crank journals 11 to 15 and the crank pins 24 to 27 that are adjacent to each other in the direction along the axis Ax1 are respectively connected by crank webs 16 to 23, each of which extends in a direction that intersects the axis Ax1. The crank pins 24 to 27 are respectively connected to tip portions of the crank webs 16 to 23, and center axes thereof are eccentric with respect to the axis Ax1. In other end portions of the crank webs 16 to 23, counterweights 28 to 35 are respectively and integrally formed with the crank webs 16 to 23.

In this embodiment, there is a case where the crank journal 11, the crank journal 12, the crank journal 13, the crank journal 14, and the crank journal 15 will be described as a #1 crank journal, a #2 crank journal, a #3 crank journal, a #4 crank journal, and a #5 crank journal, respectively.

The journal bearings 36 to 45 are inserted between the shaft support section (not illustrated) of the cylinder block and the crank journals 11 to 15, respectively. Each of the journal bearings 36 to 45 has a semicircular shape in front view in the direction along the axis Ax1 of the crankshaft 1. Each of the journal bearings 36 to 45 is a slide bearing that is formed by using a metal material. The journal bearings 36, 38, 40, 42, 44 are the “upper journal bearings” that are disposed on upper sides (cylinder head sides) of the crank journals 11 to 15 to cover upper-half circumferences of the crank journals 11 to 15, respectively. Meanwhile, the journal bearings 37, 39, 41, 43, 45 are “lower journal bearings” that are disposed on lower sides (oil pan sides) of the crank journals 11 to 15 to cover lower-half circumferences of the crank journals 11 to 15, respectively.

The upper journal bearing 36 and the lower journal bearing 37 are annularly attached to the #1 crank journal 11, the upper journal bearing 38 and the lower journal bearing 39 are annularly attached to the #2 crank journal 12, the upper journal bearing 40 and the lower journal bearing 41 are annularly attached to the #3 crank journal 13, the upper journal bearing 42 and the lower journal bearing 43 are annularly attached to the #4 crank journal 14, and the upper journal bearing 44 and the lower journal bearing 45 are annularly attached to the #5 crank journal 15. Although details will be described below, the journal bearings 38, 39, 42, 43 correspond to the “some journal bearings”, and the journal bearings 36, 37, 40, 41, 44, 45 correspond to the “remaining journal bearings”. In this embodiment, the journal bearings 42, 43 correspond to the “first journal bearings”.

A minute clearance is provided in a portion between a respective pair of the journal bearings 36 to 45 and respective one of the crank journals 11 to 15. In the minute clearance, the crankshaft 1 can rotate about the axis Ax1, and an oil film is formed. As an oil supply port to form this film, an oil hole connected to the oil gallery 50 is opened in each of the upper journal bearings 36, 38, 40, 42, 44. In other words, in the crankshaft bearing structure 100 according to this embodiment, the oil is supplied to the portions between the journal bearings 36 to 45 and the crank journals 11 to 15 through the oil holes of all the upper journal bearings 36, 38, 40, 42, 44.

Each of the thrust bearings 46 to 49 is a plate-shaped slide bearing that has a semicircular shape in the front view in the direction along the axis Ax1 of the crankshaft 1. The thrust bearings 46, 47 are respectively arranged adjacent to one sides of the journal bearings 42, 43 in the direction along the axis Ax1. The thrust bearings 48, 49 are respectively arranged adjacent to the other sides of the journal bearings 42, 43 on the one side in the direction along the axis Ax1.

The oil gallery 50 is an oil passage that is formed in the cylinder block, which is not illustrated. The oil pump 51 is connected to the oil gallery 50 so as to supply the oil stored in the oil pan to the oil gallery 50. In this embodiment, so-called low-viscosity oil is adopted as the oil. More specifically, oil with viscosity of any of OW-8 to OW-30, which is defined by the Society of Automotive Engineers, Inc., is adopted.

### 2. Arrangement Mode of Thrust Bearings 46 to 49

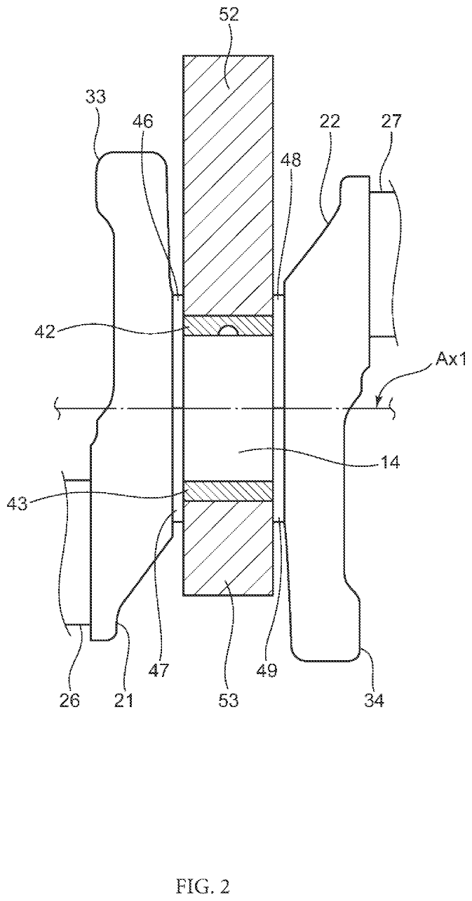

A description will be made on an arrangement mode of the thrust bearings 46 to 49 with reference to FIG. 2. FIG. 2 schematically illustrates the arrangement mode, and thus an actual shape of each portion may differ.

As illustrated in FIG. 2, the upper journal bearing 42 and the lower journal bearing 43 are annularly attached to the crank journal 14. The oil from the oil gallery 50 is supplied to the portion between the crank journal 14 and a pair of the journal bearings 42, 43.

The crank journal 14 is supported by a bulkhead 52 and a bearing cap 53 in the cylinder block with the journal bearings 42, 43 being held therebetween in a manner to allow rotation of the crankshaft 1. In this embodiment, a combination of the bulkhead 52 and the bearing cap 53 corresponds to the “shaft support section”.

Each of the upper thrust bearing 46 and the upper thrust bearing 48 is attached to respective side of the bulkhead 52 in the direction along the axis Ax1 of the crankshaft 1. Meanwhile, each of the lower thrust bearing 47 and the lower thrust bearing 49 is attached to respective side of the bearing cap 53 in the direction along the axis Ax1 of the crankshaft 1.

In the direction along the axis Ax1 of the crankshaft 1, the counterweight 33 is located on an opposite side of the upper thrust bearing 46 from the bulkhead 52, and a crank web 22 is located on an opposite side of the upper thrust bearing 48 from the bulkhead 52.

In the direction along the axis Ax1 of the crankshaft 1, the crank web 21 is located on an opposite side of the lower thrust bearing 47 from the bearing cap 53, and the counterweight 34 is located on an opposite side of the lower thrust bearing 49 from the bearing cap 53.

### 3. Shaft Internal Oil Paths 54 to 59 in Crankshaft 1

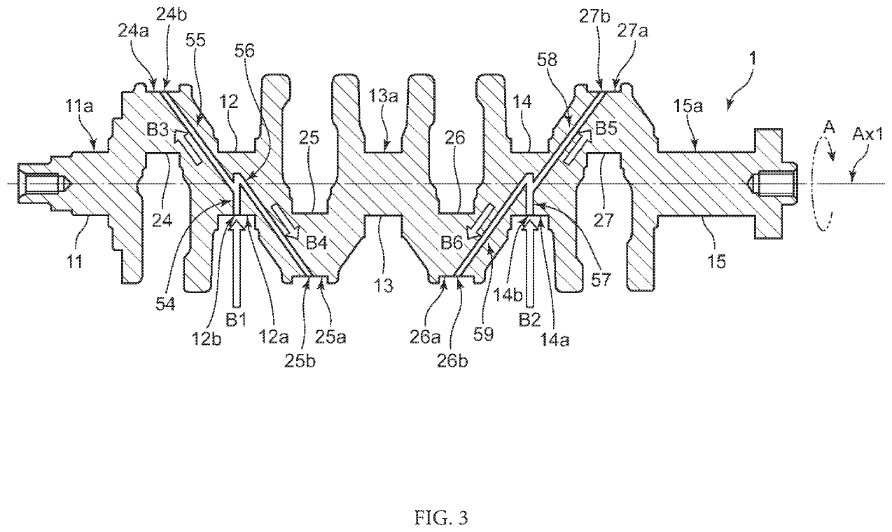

The crankshaft 1 according to this embodiment has shaft internal oil paths 54 to 59 that are formed in the crankshaft 1 and are oil distribution paths. A description will be made on the shaft internal oil paths 54 to 59, which are provided to the crankshaft 1, with reference to FIG. 3.

As illustrated in FIG. 3, on the crankshaft 1, an opening is not provided to outer circumferential surfaces 11a, 13a, 15a of the #1, #3, and #5 crank journals 11, 13, 15. On the contrary, openings 12b, 14b are respectively provided to outer circumferential surfaces 12a, 14a of the #2 and #4 crank journals 12, 14. The opening 12b is an inlet from which the oil enters the shaft internal oil path 54. The opening 14b is an inlet from which the oil enters the shaft internal oil path 57.

The shaft internal oil path 54 is formed from the outer circumferential surface 12a of the crank journal 12 in a manner to extend in an orthogonal direction to the axis Ax1 of the crankshaft 1. Then, inside the crankshaft 1, the two shaft internal oil paths 55, 56 are connected to the shaft internal oil path 54. The two shaft internal oil paths 55, 56 are formed to extend in an oblique direction to the axis Ax1 of the crankshaft 1.

The shaft internal oil path 55 is formed to have an opening 24b as a terminal end that is provided to an outer circumferential surface 24a of the crank pin 24. The shaft internal oil path 56 is formed to have an opening 25b as a terminal end that is provided to an outer circumferential surface 25a of the crank pin 25. Meanwhile, in the crankshaft bearing structure 100 according to this embodiment, a shaft internal oil path is not formed from the outer circumferential surface 24a of the crank pin 24 toward the crank journal 11 on the crankshaft 1, and a shaft internal oil path is not formed from the outer circumferential surface 25a of the crank pin 25 toward the crank journal 13.

The shaft internal oil path 57 is formed from the outer circumferential surface 14a of the crank journal 14 in a manner to extend in the orthogonal direction to the axis Ax1 of the crankshaft 1. Then, inside the crankshaft 1, the two shaft internal oil paths 58, 59 are connected to the shaft internal oil path 57. The two shaft internal oil paths 58, 59 are formed to extend in the oblique direction to the axis Ax1 of the crankshaft 1.

The shaft internal oil path 58 is formed to have an opening 27b as a terminal end that is provided to an outer circumferential surface 27a of the crank pin 27. The shaft internal oil path 59 is formed to have an opening 26b as a terminal end that is provided to an outer circumferential surface 26a of the crank pin 26. Meanwhile, in the crankshaft bearing structure 100 according to this embodiment, a shaft internal oil path is not formed from the outer circumferential surface 27a of the crank pin 27 toward the crank journal 15 on the crankshaft 1, and a shaft internal oil path is not formed from the outer circumferential surface 26a of the crank pin 26 toward the crank journal 13.

As indicated by an arrow B1, the oil that is supplied from the oil gallery 50 to the portion between the #2 crank journal 12 and the pair of the journal bearings 38, 39 is partially introduced into the shaft internal oil path 54. Then, inside the crankshaft 1, the oil that is introduced into the shaft internal oil path 54 is distributed into the shaft internal oil path 55 and the shaft internal oil path 56, each of which is connected to the shaft internal oil path 54. As indicated by arrows B3, B4, the oil is supplied from the shaft internal oil path 55 to a portion between the connecting rod bearing (not illustrated) and the crank pin 24 through the opening 24b, and is supplied from the shaft internal oil path 56 to a portion between the connecting rod bearing (not illustrated) and the crank pin 25 through the opening 25b.

In the crankshaft bearing structure 100 according to this embodiment, the shaft internal oil path is neither formed between the outer circumferential surface 24a of the crank pin 24 and the outer circumferential surface 11a of the #1 crank journal 11 nor between the outer circumferential surface 25a of the crank pin 25 and the outer circumferential surface 13a of the #3 crank journal 13. Thus, even when the crankshaft 1 rotates as indicated by an arrow A, the oil that is supplied to the portion between the #1 crank journal 11 and the pair of the journal bearings 36, 37 and the portion between the #3 crank journal 13 and the pair of the journal bearings 40, 41 is not drawn to the crank pins 24, 25.

As indicated by an arrow B2, the oil that is supplied from the oil gallery 50 to the portion between the #4 crank journal 14 and the pair of the journal bearings 42, 43 is partially introduced into the shaft internal oil path 57. Then, inside the crankshaft 1, the oil that is introduced into the shaft internal oil path 57 is distributed into the shaft internal oil path 58 and the shaft internal oil path 59, each of which is connected to the shaft internal oil path 57. As indicated by arrows B5, B6, the oil is supplied from the shaft internal oil path 58 to a portion between the connecting rod bearing (not illustrated) and the crank pin 26 through the opening 26b, and is supplied from the shaft internal oil path 59 to a portion between the connecting rod bearing (not illustrated) and the crank pin 27 through the opening 27b.

In the crankshaft bearing structure 100 according to this embodiment, similar to the above, the shaft internal oil path is neither formed between the outer circumferential surface 27a of the crank pin 27 and the outer circumferential surface 15a of the #5 crank journal 15 nor between the outer circumferential surface 26a of the crank pin 26 and the outer circumferential surface 13a of the #3 crank journal 13. Thus, even when the crankshaft 1 rotates as indicated by the arrow A, the oil that is supplied to the portion between the #3 crank journal 13 and the pair of the journal bearings 40, 41 and the portion between the #5 crank journal 15 and the pair of the journal bearings 44, 45 is not drawn to the crank pins 26, 27.

### 4. Detailed Structures of Journal Bearings 36 to 45

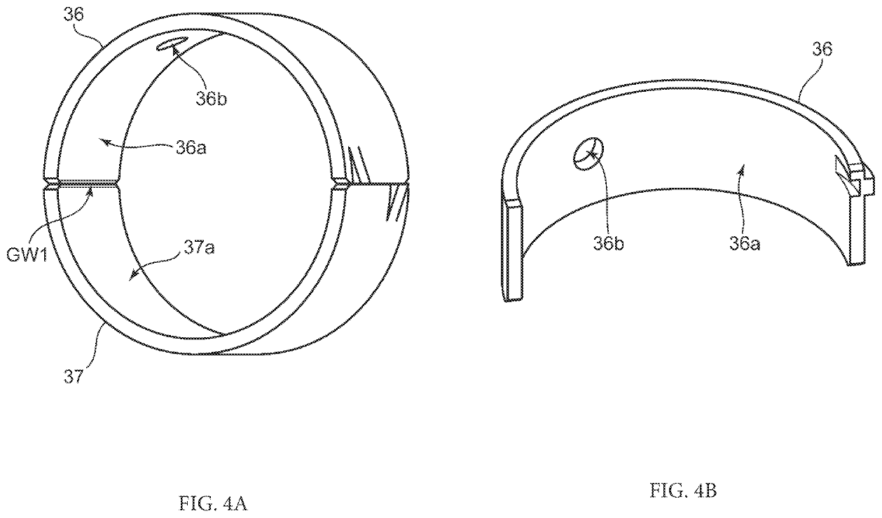

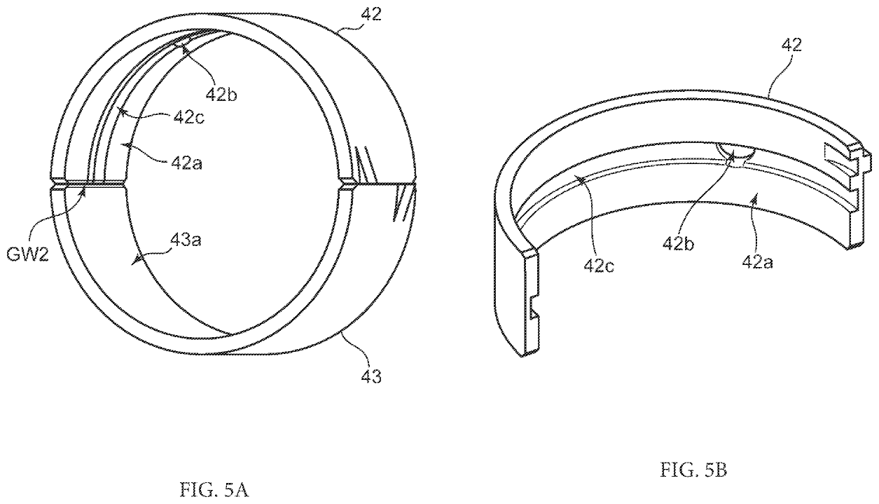

A description will be made on detailed structures of the journal bearings 36 to 45 with reference to FIGS. 4A-4B and FIGS. 5A-5B.

In the crankshaft bearing structure 100 according to this embodiment, the pairs of the journal bearings 38, 39, 42, 43 that are annularly and respectively attached to the #2 and #4 crank journals 12, 14 each have a partial structural difference from the pairs of the journal bearings 36, 37, 40, 41, 44, 45 that are annularly and respectively attached to the #1, #3, #5 crank journals 11, 13, 15. FIGS. 4A and 4B illustrate the journal bearings 36, 37 as examples of the journal bearings 36, 37, 40, 41, 44, 45 that are annularly and respectively attached to the #1, #3, #5 crank journals 11, 13, 15. FIGS. 5A and 5B illustrate the journal bearings 42, 43 as examples of the journal bearings 38, 39, 42, 43 that are annularly and respectively attached to the #2 and #4 crank journals 12, 14.

As illustrated in FIG. 4A, each of the upper journal bearing 36 and the lower journal bearing 37 that are annularly attached to the #1 crank journal 11 has the semicircular shape in the front view in the direction along the axis Ax1 of the crankshaft 1. The upper journal bearing 36 and the lower journal bearing 37 are annularly attached to the #1 crank journal 11 in a state where circumferential end portions thereof abut each other.

As illustrated in FIGS. 4A and 4B, the upper journal bearing 36 is formed with an oil hole 36b near a top thereof. As it has been described above with reference to FIG. 1, the oil gallery 50 is connected to the oil hole 36b of the upper journal bearing 36, and the oil from the oil gallery 50 is supplied to the portion between the #1 crank journal 11 and the pair of the journal bearings 36, 37 through the oil hole 36b.

In the upper journal bearing 36 and the lower journal bearing 37, inner circumferential surfaces 36a, 37a are formed by rotation surfaces, each of which is generated with a linear line parallel to the axis Ax1 (see FIGS. 1, 3) of the crankshaft 1 as a generating line. In other words, in the upper journal bearing 36 and the lower journal bearing 37, grooves that extend in the circumferential direction (circumferential grooves) are not formed in the inner circumferential surfaces 36a, 37a, and thus the smooth inner circumferential surfaces 36a, 37a are formed.

Here, each of end surfaces in the circumferential direction of the upper journal bearing 36 and the lower journal bearing 37 is configured as an oblique surface that is oriented in an oblique direction to the circumferential direction and extends in the direction along the axis Ax1 of the crankshaft 1. Then, as illustrated in FIG. 4A, when the circumferential end portions of the upper journal bearing 36 and the lower journal bearing 37 abut each other, a groove GW1 that extends in a width direction of the journal bearings 36, 37 is formed by a clearance between each pair of the end surfaces. This groove GW1 functions as a discharge path, through which the oil supplied to the portion between the #1 crank journal 11 and the pair of the journal bearings 36, 37 and a granular foreign substance such as metal powder mixed in such a portion are discharged to the outside.

The journal bearings 40, 41, 44, 45 have the same structures as the journal bearings 36, 37.

As illustrated in FIG. 5A, each of the upper journal bearing 42 and the lower journal bearing 43 that are annularly attached to the #4 crank journal 14 also has the semicircular shape in the front view in the direction along the axis Ax1 of the crankshaft 1. The upper journal bearing 42 and the lower journal bearing 43 are annularly attached to the #4 crank journal 14 in a state where circumferential end portions thereof abut each other.

As illustrated in FIGS. 5A and 5B, the upper journal bearing 42 is also formed with an oil hole 42b near a top thereof. As it has been described above with reference to FIG. 1, the oil gallery 50 is connected to the oil hole 42b of the upper journal bearing 42, and the oil from the oil gallery 50 is supplied to the portion between the #4 crank journal 14 and the pair of the journal bearings 42, 43 through the oil hole 42b.

Of the upper journal bearing 42 and the lower journal bearing 43, in the lower journal bearing 43, an inner circumferential surface 43a is formed by a rotation surface that is generated with a linear line parallel to the axis Ax1 (see FIGS. 1, 3) of the crankshaft 1 as a generating line. In other words, in the lower journal bearing 43, a groove that extends in the circumferential direction (a circumferential groove) is not formed in the inner circumferential surface 43a, and thus the smooth inner circumferential surface 43a is formed.

Meanwhile, as illustrated in FIGS. 5A and 5B, in the upper journal bearing 42, which is formed with the oil hole 42b, an inner circumferential surface 42a is formed with a circumferential groove 42c that extends in the circumferential direction. The circumferential groove 42c is connected to the oil hole 42b and is formed from the end portion on one end side to the end portion on the other end side in the circumferential direction. The circumferential groove 42c, which is formed in the upper journal bearing 42, has a function as a guide path for the oil supplied from the oil hole 42b.

Here, each of end surfaces in the circumferential direction of the upper journal bearing 42 and the lower journal bearing 43 is also configured as an oblique surface that is oriented in the oblique direction to the circumferential direction and extends in the direction along the axis Ax1 of the crankshaft 1. Then, as illustrated in FIG. 5A, when the circumferential end portions of the upper journal bearing 42 and the lower journal bearing 43 abut each other, a groove GW2 that extends in a width direction of the journal bearings 42, 43 is formed by a clearance between each pair of the end surfaces. This groove GW2 also functions as a discharge path, through which the oil supplied to the portion between the #4 crank journal 14 and the pair of the journal bearings 42, 43 and the granular foreign substance such as the metal powder mixed in such a portion are discharged to the outside.

The journal bearings 38, 39 also have the same structures as the journal bearings 42, 43.

### 5. Oil Flow into Portions Between Journal Bearings 36 to 45 and Crank Journals 11 to 15

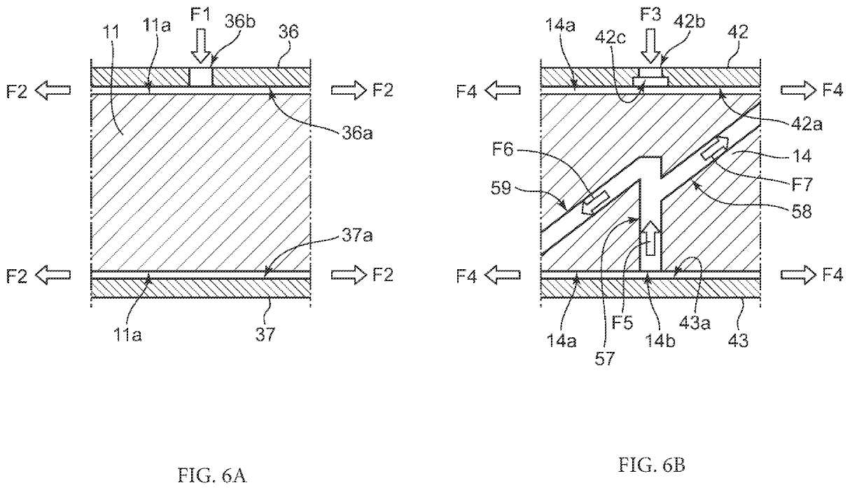

A description will be made on an oil flow into the portion between each pair of the journal bearings 36 to 45 and respective one of the crank journals 11 to 15 with reference to FIGS. 6A-6B. FIG. 6A illustrates the oil flow into the portion between the #1 crank journal 11 and the pair of the journal bearings 36, 37 as an example of the oil flow into the portion between each pair of the journal bearings 36, 37, 40, 41, 44, 45 and respective one of the crank journals 11, 13, 15. FIG. 6B illustrates the oil flow into the portion between the #4 crank journal 14 and the pair of the journal bearings 42, 43 as an example of the oil flow into the portion between each pair of the journal bearings 38, 39, 42, 43 and respective one of the crank journals 12, 14.

As illustrated in FIG. 6A, the oil is supplied to the portion between the #1 crank journal 11, in which the opening connected to the shaft internal oil path is not provided to the outer circumferential surface 11a, and the pair of the journal bearings 36, 37, which are annularly attached to the #1 crank journal 11, through the oil hole 36b provided to the upper journal bearing 36 (an arrow F1). Then, the supplied oil lubricates the portion between the outer circumferential surface 11a of the #1 crank journal 11 and each of the inner circumferential surfaces 36a, 37a of the journal bearings 36, 37, and is discharged to the outside from each of the end portions in the width direction (the end portions in the direction along the axis Ax1 of the crankshaft 1) of the journal bearings 36, 37 (arrows F2).

The Flow of the oil that is supplied to the portion between #3 crank journal 13 and the pair of the journal bearings 40, 41 and the flow of the oil that is supplied to the portion between the #5 crank journal 15 and the pair of the journal bearings 44, 45 are the same as the oil flow that has been described with reference to FIG. 6A.

As illustrated in FIG. 6B, the oil is also supplied to the portion between the #4 crank journal 14, in which the opening 14b connected to the shaft internal oil path 57 is provided to the outer circumferential surface 14a, and the pair of the journal bearings 42, 43, which are annularly attached to the #4 crank journal 14, through the oil hole 42b provided to the upper journal bearing 42 (an arrow F3). Then, the supplied oil lubricates the portion between the outer circumferential surface 14a of the #4 crank journal 14 and each of the inner circumferential surfaces 42a, 43a of the journal bearings 42, 43, and is partially discharged to the outside from each of the end portions in the width direction (the end portions in the direction along the axis Ax1 of the crankshaft 1) of the journal bearings 42, 43 (arrows F4). The oil that is discharged from the end portions in the width direction lubricates the thrust bearings 46 to 49. A description thereon will be made below.

A remaining portion of the oil that is supplied to the portion between the #4 crank journal 14 and the pair of the journal bearings 42, 43 is introduced into the shaft internal oil path 57 from the opening 14b provided to the outer circumferential surface 14a of the #4 crank journal 14 (an arrow F5). The oil that is introduced into the shaft internal oil path 57 is distributed into the shaft internal oil paths 58, 59, each of which is connected to the shaft internal oil path 57, and is then supplied to the crank pins 26, 27 that are adjacent to the #4 crank journal 14 in the direction along the axis Ax1 of the crankshaft 1 (arrows F6, F7). Since the upper journal bearing 42 is formed with the circumferential groove 42c that is connected to the oil hole 42b and extends in the circumferential direction, the oil is favorably introduced into the shaft internal oil path 57.

The flow of the oil into the portion between the #2 crank journal 12 and the pair of the journal bearings 38, 39 is the same as the oil flow that has been described above with reference to FIG. 6B.

### 6. Lubrication of Thrust Bearings 46 to 49

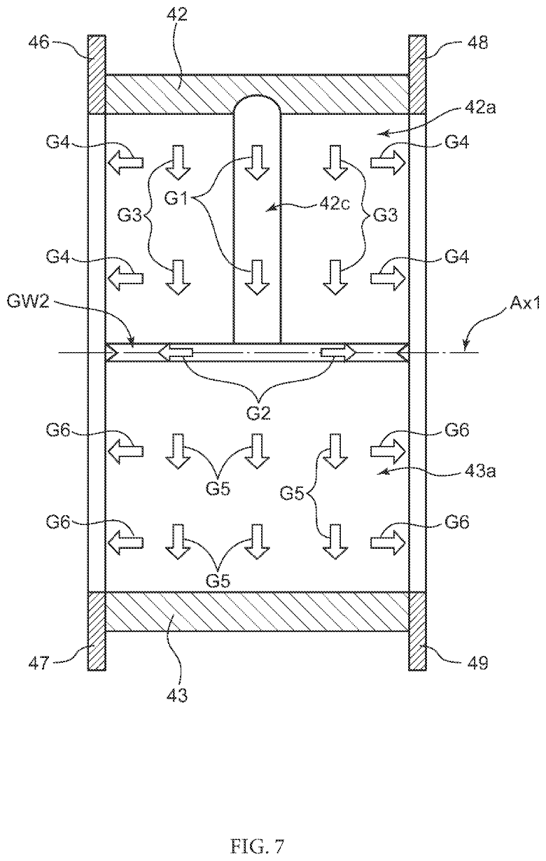

In the crankshaft bearing structure 100 according to this embodiment, each of the thrust bearings 46 to 48 is arranged adjacent to respective one of both of the sides of the journal bearings 42, 43, each of which is annularly attached to the #4 crank journal 14, in the direction along the axis Ax1 of the crankshaft 1. A description will be made on lubrication of the thrust bearings 46 to 49 by the oil that is supplied from the oil hole 42b, which is provided to the upper journal bearing 42, to the portion between the #4 crank journal 14 and the pair of the journal bearings 42, 43 with reference to FIG. 7.

The oil that is supplied from the oil gallery 50 through the oil hole 42b flows to spread into the entire portion between the #4 crank journal 14 and the pair of the journal bearings 42, 43 in conjunction with the rotation of the crankshaft 1 (arrows G1, G2, G3, G5). In this way, the oil film is formed between the #4 crank journal 14 and the pair of the journal bearings 42, 43, and thereby lubricates the portion therebetween.

Since the upper journal bearing 42 is formed with the circumferential groove 42c, a larger amount of the oil is secured in the portion between the #4 crank journal 14 and the pair of the journal bearings 42, 43 than an amount of the oil supplied to the portion between each of the #1, #3, #5 crank journals 11, 13, 15 and the respective pair of the journal bearings 36, 37, 40, 41, 44, 45.

As described above, the oil that is supplied to the portion between the #4 crank journal 14 and the pair of the journal bearings 42, 43 is partially discharged to the outside in the direction along the axis Ax1 of the crankshaft 1 from the end portions in the width direction (arrows G4, G6). Then, the discharged oil is supplied to the thrust bearings 46 to 49 that are respectively arranged adjacent to the journal bearings 42, 43, and lubricates the thrust bearings 46 to 49. Due to the provision of the circumferential groove 42c to the upper journal bearing 42, the amount of the oil that is supplied to the portion between the #4 crank journal 14 and the pair of the journal bearings 42, 43 is larger than the amount of the oil that is supplied to the portion between each of the #1, #3, #5 crank journals 11, 13, 15 and the respective pair of the journal bearings 36, 37, 40, 41, 44, 45. Thus, it is possible to secure an amount of the oil to be supplied to the thrust bearings 46 to 49.

Since the groove GW2 is formed in the abutting portions of the upper journal bearing 42 and the lower journal bearing 43, the oil is easily supplied to the thrust bearings 46 to 49 through the groove GW2 as the guide path.

### 7. Effects

In the crankshaft bearing structure 100 according to this embodiment, each of the upper journal bearings 38, 42 has the circumferential groove 42c. Accordingly, the relatively larger amount of the oil than the amount of the oil supplied to the portion between each of the #1, #3, #5 crank journals 11, 13, 15 and the respective pair of the journal bearings 36, 37, 40, 41, 44, 45 is supplied to the portion between each of the #2 and #4 crank journals 12, 14, to which the journal bearings 38, 39, 42, 43 are annularly and respectively attached, and the respective pair of the journal bearings 38, 40, 42, 43. Then, in the crankshaft bearing structure 100, the thrust bearings 46 to 49 are attached to the shaft support section (the bulkhead 52 and the bearing cap 53) that supports the #4 crank journal 14, to which the journal bearings 42, 43 are annularly attached. In other words, in the crankshaft bearing structure 100, the thrust bearings 46 to 49 are respectively disposed to portions corresponding to the journal bearings 42, 43. Accordingly, the relatively large amount of the oil is discharged in the direction along the axis Ax1 of the crankshaft 1 from the portions between the #4 crank journal 14 and the journal bearings 42, 43, and the thrust bearings 46 to 49 are disposed in such portions. As a result, even when a temperature of the low-viscosity oil becomes high, the lubrication of the thrust bearings 46 to 49 is maintained.

In the crankshaft bearing structure 100 according to this embodiment, each of the thrust bearings 46 to 49 is arranged adjacent to respective one of both of the sides of the journal bearings 42, 43, each of which is annularly attached to the #4 crank journal 14, in the width direction (in the direction along the axis Ax1 of the crankshaft 1) of the journal bearings 42, 43. Therefore, it is possible to reliably lubricate the thrust bearings 46 to 49 with the relatively large amount of the oil that is discharged in the width direction from the portion between the #4 crank journal 14 and the pair of the journal bearings 42, 43 while restricting the movement of the crankshaft 1 in the direction along the axis Ax1.

In the crankshaft bearing structure 100 according to this embodiment, since the circumferential groove 42c is provided to the inner circumferential surface 42a of the upper journal bearing 42, the oil that is supplied through the oil hole 42b of the upper journal bearing 42 is guided toward the lower journal bearing 43 in conjunction with the rotation of the crankshaft 1.

Meanwhile, the lower journal bearing 43 that is disposed vertically below the upper journal bearing 42 is not provided with the circumferential groove, and this is advantageous for securing an appropriate hydraulic pressure between the lower journal bearing 43 and the #4 crank journal 14.

In the crankshaft bearing structure 100 according to this embodiment, since the groove GW2 is formed in the portion where the circumferential end portions of the upper journal bearing 42 and the lower journal bearing 43 abut each other, the oil is easily supplied from the portion between the #4 crank journal 14 and the pair of the journal bearings 42, 43 to the thrust bearings 46 to 49 that are respectively arranged adjacent to the journal bearings 42, 43.

In the crankshaft bearing structure 100 according to this embodiment, since the thrust bearings are configured by combining the upper thrust bearings 46, 48 and the lower thrust bearings 47, 49, the thrust bearings 46 to 49 are easily attached to the bulkhead 52 and the bearing cap 53.

In the crankshaft bearing structure 100 according to this embodiment, the circumferential groove is not formed in the inner circumferential surfaces 36a, 37a of the journal bearings 36, 37, 40, 41, 44, 45. Therefore, even when the low-viscosity oil is used and the temperature of the low-viscosity oil becomes high, it is possible to secure the appropriate hydraulic pressure between each of the #1, #3, #5 crank journals 11, 13, 15 and the respective pair of the journal bearings 36, 37, 40, 41, 44, 45.

As it has been described so far, in the crankshaft bearing structure 100 according to this embodiment, even when the low-viscosity oil is used in the engine, the thrust bearings 46 to 49 can be lubricated.

### Second Embodiment

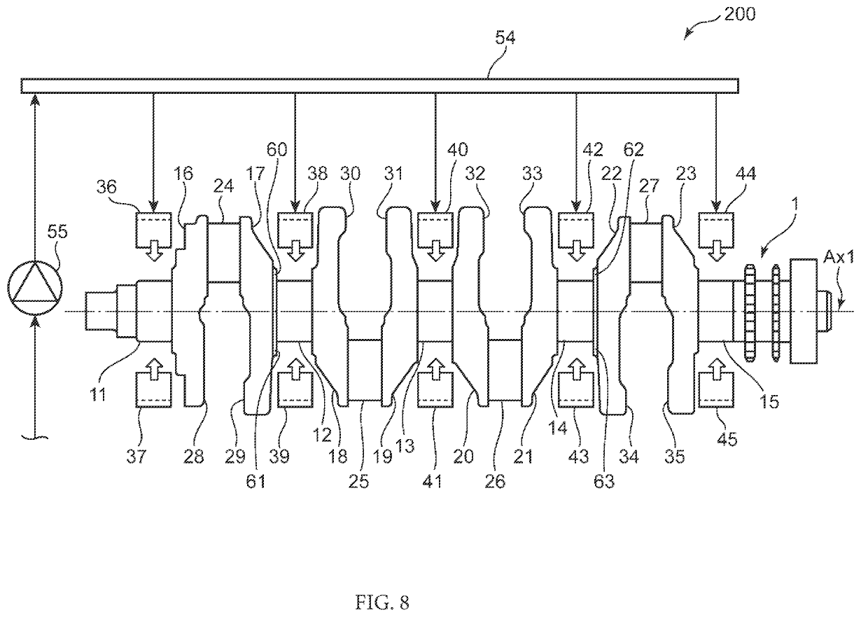

A description will be made on a crankshaft bearing structure 200 according to a second embodiment of the present disclosure with reference to FIG. 8. The crankshaft bearing structure 200 according to this embodiment differs from the crankshaft bearing structure in the above first embodiment in terms of the arrangement mode of the thrust bearings 60 to 63, and the rest of the configuration thereof is the same as the configuration in the above first embodiment.

As illustrated in FIG. 8, thrust bearings 60, 61 are respectively arranged adjacent to the journal bearings 38, 39, each of which is annularly attached to the #2 crank journal 12. More specifically, the thrust bearing 60 is attached to the crank web 17 side of the bulkhead 52 that supports the #2 crank journal 12. The thrust bearing 61 is also attached to the crank web 17 side of the bearing cap 53 that supports the #2 crank journal 12. Similar to the thrust bearings 46 to 49 in the above first embodiment, the thrust bearings 60, 61 each have the semicircular shape in the front view in the direction along the axis Ax1 of the crankshaft 1.

Thrust bearings 62, 63 are respectively arranged adjacent to the journal bearings 42, 43, each of which is annularly attached to the #4 crank journal 14. More specifically, the thrust bearing 62 is attached to the crank web 22 side of the bulkhead 52 that supports the #4 crank journal 14. The thrust bearing 63 is also attached to the crank web 22 side of the bearing cap 53 that supports the #4 crank journal 14. Similar to the thrust bearings 46 to 49 in the above first embodiment, the thrust bearings 62, 63 each have the semicircular shape in the front view in the direction along the axis Ax1 of the crankshaft 1.

The configurations of the journal bearings 36 to 45 are the same to those in the above first embodiment.

Also, in the crankshaft bearing structure 200 according to this embodiment, similar to the crankshaft bearing structure 100 according to the above first embodiment, even when the low-viscosity oil is used in the engine, the thrust bearings 60 to 63 can be lubricated.

### Modified Examples

In the above first embodiment and the above second embodiment, the four-cylinder engine is adopted as the engine, to which each of the crankshaft bearing structures 100, 200 is applied. However, the present disclosure can also be applied to engines with two cylinders, three cylinders, five cylinders, and more.

In the crankshaft bearing structure 100 according to the above first embodiment, of the journal bearings 38, 39 that are annularly attached to the #2 crank journal 12, the upper journal bearing 38 is provided with the circumferential groove 42c. However, in the present disclosure, it is also possible not to provide the circumferential groove to the upper and lower journal bearings 38, 39 that are annularly attached to the #2 crank journal 12.

What is claimed is:

1. A crankshaft bearing structure comprising:
a crankshaft having plural crank journals, each of which extends in a specified direction, and which are disposed at mutually-spaced intervals in the specified direction;
a cylinder block having plural shaft support sections, each of which is disposed to surround a radially outer side of a respective one of the plural crank journals, and supporting the crankshaft in a rotatable manner by the plural shaft support sections;
plural journal bearings, each of which is provided between a respective one of the plural crank journals and a respective one of the plural shaft support sections and is annularly attached to the respective one of the plural crank journals when the crankshaft is rotating; and
a thrust bearing attached to each of some shaft support sections of the plural shaft support sections to restrict movement of the crankshaft in the specified direction, wherein
the cylinder block has an oil path,
some journal bearings of the plural journal bearings each have: an oil hole that is provided in an upper portion and is connected to the oil path, and through which oil from the oil path is supplied to a portion between the journal bearing and the crank journal; and a circumferential groove that is provided in an inner circumferential surface of the journal bearing, is connected to the oil hole, and extends in a circumferential direction, and
the thrust bearing is attached to the shaft support section for supporting the crank journal, to which the some journal bearings are annularly attached.

2. The crankshaft bearing structure according to claim 1, wherein
the some journal bearings include a specific single first journal bearing, and
the thrust bearings include: a first thrust bearing that is arranged adjacent to one side of the first journal bearing in the specified direction; and a second thrust bearing that is arranged adjacent to an opposite side of the first journal bearing from the one side in the specified direction.

3. The crankshaft bearing structure according to claim 2, wherein
the plural crank journals include: a specific single first crank journal; and a specific single second crank journal that is a different crank journal from the first crank journal,
the some journal bearings include: a first journal bearing that is annularly attached to the first crank journal; and a second journal bearing that is annularly attached to the second crank journal, and
the thrust bearings include: a first thrust bearing that is arranged adjacent to one side of the first journal bearing in the specified direction; and a second thrust bearing that is arranged adjacent to an opposite side of the second journal bearing from the one side in the specified direction.

4. The crankshaft bearing structure according to claim 3, wherein
each of the plural journal bearings is constructed of an upper journal bearing and a lower journal bearing, each of which has a semicircular shape in front view in the specified direction, and
the circumferential groove in each of the some journal bearings is only provided to the upper journal bearing.

5. The crankshaft bearing structure according to claim 4, wherein
a circumferential end surface of each of the upper journal bearing and the lower journal bearing is formed such that, when circumferential end portions of the upper journal bearing and the lower journal bearing abut each other, a groove extending in the specified direction is formed on an inner circumferential surface side of the abutting portion.

6. The crankshaft bearing structure according to claim 5, wherein
the thrust bearing is constructed of an upper thrust bearing and a lower thrust bearing, each of which has a semicircular shape in the front view in the specified direction.

7. The crankshaft bearing structure according to claim 6, wherein
a remaining journal bearing that differs from the some journal bearings of the plural journal bearings has: an inner circumferential surface that is configured as a rotation surface generated with a linear line parallel to the specified direction as a generating line; and an oil hole that is provided in an upper portion and is connected to the oil path, and through which the oil from the oil path is supplied to a portion between the inner circumferential surface and the crank journal.

8. The crankshaft bearing structure according to claim 1, wherein
the plural crank journals include: a specific single first crank journal; and a specific single second crank journal that is a different crank journal from the first crank journal,
the some journal bearings include: a first journal bearing that is annularly attached to the first crank journal; and a second journal bearing that is annularly attached to the second crank journal, and
the thrust bearings include: a first thrust bearing that is arranged adjacent to one side of the first journal bearing in the specified direction; and a second thrust bearing that is arranged adjacent to an opposite side of the second journal bearing from the one side in the specified direction.

9. The crankshaft bearing structure according to claim 1, wherein
each of the plural journal bearings is constructed of an upper journal bearing and a lower journal bearing, each of which has a semicircular shape in front view in the specified direction, and
the circumferential groove in each of the some journal bearings is only provided to the upper journal bearing.

10. The crankshaft bearing structure according to claim 1, wherein
the thrust bearing is constructed of an upper thrust bearing and a lower thrust bearing, each of which has a semicircular shape in the front view in the specified direction.

11. The crankshaft bearing structure according to claim 1, wherein
a remaining journal bearing that differs from the some journal bearings of the plural journal bearings has: an inner circumferential surface that is configured as a rotation surface generated with a linear line parallel to the specified direction as a generating line; and an oil hole that is provided in an upper portion and is connected to the oil path, and through which the oil from the oil path is supplied to a portion between the inner circumferential surface and the crank journal.

12. The crankshaft bearing structure according to claim 2, wherein
each of the plural journal bearings is constructed of an upper journal bearing and a lower journal bearing, each of which has a semicircular shape in front view in the specified direction, and
the circumferential groove in each of the some journal bearings is only provided to the upper journal bearing.

13. The crankshaft bearing structure according to claim 12, wherein
a circumferential end surface of each of the upper journal bearing and the lower journal bearing is formed such that, when circumferential end portions of the upper journal bearing and the lower journal bearing abut each other, a groove extending in the specified direction is formed on an inner circumferential surface side of the abutting portion.

14. The crankshaft bearing structure according to claim 13, wherein
the thrust bearing is constructed of an upper thrust bearing and a lower thrust bearing, each of which has a semicircular shape in the front view in the specified direction.

15. The crankshaft bearing structure according to claim 14, wherein
a remaining journal bearing that differs from the some journal bearings of the plural journal bearings has: an inner circumferential surface that is configured as a rotation surface generated with a linear line parallel to the specified direction as a generating line; and an oil hole that is provided in an upper portion and is connected to the oil path, and through which the oil from the oil path is supplied to a portion between the inner circumferential surface and the crank journal.

16. The crankshaft bearing structure according to claim 8, wherein
each of the plural journal bearings is constructed of an upper journal bearing and a lower journal bearing, each of which has a semicircular shape in front view in the specified direction, and
the circumferential groove in each of the some journal bearings is only provided to the upper journal bearing.

17. The crankshaft bearing structure according to claim 16, wherein
a circumferential end surface of each of the upper journal bearing and the lower journal bearing is formed such that, when circumferential end portions of the upper journal bearing and the lower journal bearing abut each other, a groove extending in the specified direction is formed on an inner circumferential surface side of the abutting portion.

18. The crankshaft bearing structure according to claim 17, wherein
the thrust bearing is constructed of an upper thrust bearing and a lower thrust bearing, each of which has a semicircular shape in the front view in the specified direction.

19. The crankshaft bearing structure according to claim 18, wherein
a remaining journal bearing that differs from the some journal bearings of the plural journal bearings has: an inner circumferential surface that is configured as a rotation surface generated with a linear line parallel to the specified direction as a generating line; and an oil hole that is provided in an upper portion and is connected to the oil path, and through which the oil from the oil path is supplied to a portion between the inner circumferential surface and the crank journal.

20. The crankshaft bearing structure according to claim 9, wherein
a circumferential end surface of each of the upper journal bearing and the lower journal bearing is formed such that, when circumferential end portions of the upper journal bearing and the lower journal bearing abut each other, a groove extending in the specified direction is formed on an inner circumferential surface side of the abutting portion.
